(19) United States
(12) Patent Application Publication
(10) Pub. No.: US 2026/0287717 A1
(43) Pub. Date: Sep. 24, 2026

(54) Protective device for an optical sensor, in particular a lidar sensor

(71) Applicant: BMTS Technology GmbH & Co. KG, Stuttgart (DE)

(72) Inventors: Daniel Schulze, Kernen (DE); Nisar Al-Hasan, Markgroningen (DE)

(21) Appl. No.: 19/474,108

(22) PCT Filed: Apr. 12, 2024
(86) PCT No.: PCT/EP2024/060075

§ 371 Date: Oct. 9, 2025

(30) Foreign Application Priority Data
Apr. 18, 2023 (DE) 10 2023 109 693.1

(51) Int. Cl. G01S 7/481; G01S 17/931

(52) U.S. Cl. CPC G01S 7/4813; G01S 17/931

(57) ABSTRACT

The invention relates to a protective device for an optical sensor, in particular a lidar sensor (10) having a mounting area, in which an optical unit is disposed, wherein the optical unit is disposed in the area behind a transparent light-emitting surface (12), and wherein the light-emitting surface (12) is disposed and designed to transmit light, in particular laser light, in particular to transmit light from the optical unit in the direction towards the surroundings and/or to transmit light from the surroundings in the direction towards the optical unit. To enable a continuously safe operation of such optical sensors, in particular when used on a detection system of a vehicle, provision is made according to the invention for a protective device (20) to be assigned to the light-emitting surface (12), which protective device is designed to protect at least one area of the surface of the light-emitting surface (12) facing the surroundings from contamination by means of a gas flow, in that the protective device (20) has a gas guide having at least one nozzle arrangement (26), in that the nozzle arrangement (26) has at least one nozzle (25), in that the nozzle arrangement (26) is designed to generate a directed gas flow such that the gas flow on the ambient side generates a gas curtain (F1-F4) along the light-emitting surface (12) and preferably at least sectionally spaced apart from the light-emitting surface (12).

The invention relates to a protective device for an optical sensor, in particular a lidar sensor having a mounting area, in which an optical unit is disposed, wherein the optical unit is disposed in the area behind a transparent light-emitting surface, and wherein the light-emitting surface is disposed and designed to transmit light, in particular laser light, in particular to transmit light from the optical unit in the direction towards the surroundings and/or to transmit light from the surroundings in the direction towards the optical unit.

Optical sensors are increasingly being used in modern motor vehicles to monitor the surroundings. Cameras, lidar sensors and other optical sensors are often used. The relevance of these sensors is particularly high for autonomous vehicles. A basic prerequisite for the safe operation of the vehicle is the proper functioning of the sensors for 3D orientation. Contamination of the sensor surface, caused for instance by collisions with dirt particles, water or insects, is therefore inconsistent with the safe operation of the vehicle.

Various concepts are currently being pursued for cleaning the transparent light-emitting surface of the sensor surface. In the known concepts, several cleaning nozzles are used to clean the sensor surface by direct blasting it with gaseous and/or liquid media to clean the particles from the transparent light-emitting surface. In addition to cleaning using cleaning nozzles, mechanical cleaning of the surface using various wiping concepts in combination with liquid wetting is also known.

Another well-known method is ultrasonic cleaning (~35 Hz). In some cases, a liquid is first applied to the sensor surface. A piezo crystal then causes the sensor surface to vibrate, which loosens the dirt.

The known concepts attempt to clean the sensor surface as well as possible or to prevent the particles from sticking. It is technically complex to ensure continuous and complete cleaning of the surface. For instance, the maximum amount of liquid that can be carried in the vehicle is limited. This means that continuous cleaning cannot be guaranteed and the cleaning fluid must be replaced frequently.

In all mechanical cleaning concepts, a kind of blind spot occurs during cleaning. This means that there are restrictions in the sensor's field of vision.

Another disadvantage is the number of components in the known concepts. In most cases, several cleaning nozzles are used for every sensor, which have to be connected to a compressed air system or liquid system via hoses. Due to the number of components, it is often not possible to implement a compact design. In addition, the costs and complexity increase with the number of components.

In known concepts using gaseous cleaning media (e.g. compressed air), where the fluid flows directly onto the sensor surface through nozzles, an oil-free compressor concept always has to be implemented to avoid contamination of the sensor surface with oil.

In the known concepts using gaseous cleaning media, the sensor surface is cleaned based on shear stresses.

The invention addresses the problem of creating a protective device for an optical sensor, in particular a lidar sensor, of the type mentioned at the beginning, which permits continuous safe operation, in particular when used on a detection system of a vehicle.

This problem is solved in that a protective device is assigned to the light-emitting surface, which protective device is designed to protect at least one area of the surface of the light-emitting surface facing the surroundings from contamination by means of a gas flow, in that the protective device has a gas guide having at least one nozzle arrangement, in that the nozzle arrangement has at least one nozzle, in that the nozzle arrangement is designed to generate a directed gas flow such that the gas flow on the ambient side generates a gas curtain along the light-emitting surface and preferably at least sectionally spaced apart from the light-emitting surface. The distance between the nozzle outlet surface and the sensor surface is preferably at most twice as large as the characteristic length of the sensor element, for instance the diameter or the longest extent of the sensor element.

The protective device according to the invention deflects the particles in the surroundings by the gas curtain, in particular the air curtain, before they can hit the light-emitting surface. This prevents or at least greatly reduces any soiling of the light-emitting surface. The effort required to clean the sensor surface can therefore be prevented or at least greatly reduced. The gaseous fluid required to operate the protective device can be provided via a pressure system, in particular a compressed air system, for instance a compressed air system already present in the vehicle. It is conceivable that the gaseous fluid is conveyed by means of a radial compressor or a scroll compressor and made available to the nozzle arrangement. In contrast to concepts using liquid cleaning agents, air as a gaseous fluid is indefinitely available, which significantly simplifies maintenance work. Based on the solution according to the invention, continuous and permanently safe operation of the optical sensor can be achieved. Another advantage of this concept is that the gas curtain has little or no contact with the light-emitting surface. This means that the choice of compressor concept for conveying the gas flow is not subject to any restrictions with regard to the lubricant used in the compressor.

According to a preferred embodiment of the invention, provision may be made for the nozzle or at least some of the nozzles of the nozzle arrangement to have a geometry by means of which a main flow direction of the gas can be generated at the nozzle outlet, which main flow direction extends in parallel or at an angle measured perpendicular to the light-emitting surface. If the main flow direction is directed outwards at an angle to the light-emitting surface, this results in a force component in the flow that points vertically away from the light-emitting surface. Any particle hitting at high kinetic energy caused by the motion of a vehicle is safely intercepted and deflected.

Preferably, provision may be made for the main flow direction to form an angle with the light-emitting surface in the range from 0° to 60°, measured perpendicular to the light-emitting surface. The angle in the range between 0° and 20°is preferably selected for applications in trucks. An angle between 5° and 30°is particularly suitable for motor vehicles.

An optical sensor according to the invention can be designed such that the light-emitting surface is designed, at least sectionally, as a plane surface in front of which the gas curtain can be generated in the ambient area, and/or that the light-emitting surface is designed, at least sectionally, as a surface that is curved in the direction of the surroundings, in particular a cylindrical or partially cylindrical surface, in front of which the gas curtain can be generated in the surrounding area.

If a cylindrical or partially cylindrical surface is implemented on the light-emitting surface, provision may be made in particular for the main flow direction to be inclined in the circumferential direction of the cylindrical or partially cylindrical light-emitting surface, wherein the angle of inclination is preferably selected in the range from 0° to 30°. Such a design prevents the generated gas curtain from being too strongly influenced by the head wind caused by driving acting on the optical sensor.

To prevent the light-emitting surface of the optical sensor from as much exposure as possible to the gas flow of the protective device, provision may be made for the gas outlet surface at the nozzle outlet of the nozzle arrangement to be disposed spaced apart from the light-emitting surface, wherein preferably provision is made for the gas outlet surface to be disposed offset in the direction of the light-emitting surface and/or offset transversely thereto. To this end, the distance between the nozzle outlet surface and the sensor surface is preferably at most twice as large as the characteristic length of the sensor element, for instance the diameter or the longest extent of the sensor element.

According to the invention, provision may be made for the nozzle arrangement to be disposed in a lateral area of the light-emitting surface, wherein preferably provision is made for one nozzle arrangement each to be disposed on opposite ends of the light-emitting surface, and for the nozzle arrangement(s) to be disposed and designed to generate a gas curtain directed towards the opposite end of the light-emitting surface. The use of a nozzle arrangement on only one end of the light-emitting surface is particularly suitable for smaller optical sensors. For large light-emitting surfaces, it is advantageous to create a gas curtain on each of the opposite ends to achieve effective protection of the light-emitting surface.

For a compact design, provision may be made for the light-emitting surface to be delimited by a support at least in the area of one end of the light-emitting surface, and for the support to bear the nozzle arrangement, wherein preferably provision is made for the light-emitting surface to be delimited by one support each on opposite ends, and for the two supports each to bear a nozzle arrangement.

A conceivable alternative invention can be such that the light-emitting surface is delimited on opposite ends by lateral edges, and that the nozzle arrangement(s) of the protective device is/are provided in the area between these lateral edges. Such a design is particularly suitable if there is an area inside the light-emitting surface that is not required for the light transmission of the sensor. In this case, for generating one gas curtain each directed towards the assigned lateral edge it is particularly advantageous if provision is made for the protective device disposed between the lateral edges to have one nozzle arrangement each on opposite ends, each facing a lateral edge of the light-emitting surface.

An optical sensor according to the invention can be designed such that the nozzle arrangement has at least one continuous or discontinuous ring nozzle, which is assigned to a light-emitting surface designed as an at least partially circumferential surface. Based on this concept, a design can be implemented, in which the entire field of view of the sensor, preferably across the entire 360° circumference of the field of view, is not impaired.

It is also conceivable that the nozzle arrangement has a plurality of individual nozzles. A particularly effective protective device for the optical sensor is characterized in that the gas guide has two nozzle arrangements, which are disposed sequentially perpendicular to the light-emitting surface, and in that the main flow directions of the two nozzle arrangements extend in parallel to each other, or in that the main flow directions of the two nozzle arrangements extend at an angle to each other, wherein preferably provision is made for the main flow directions to extend at an angle to each other perpendicular to the light-emitting surface. Preferably, the angle can be in the range from 0° to 15°. In this way, gas flows can be achieved, which preferably each form their own gas curtain. These gas curtains are arranged sequentially perpendicular to the light-emitting surface, which provides particularly effective protection. A particle from the surroundings that has not been completely intercepted by the first gas curtain, for instance, can then be safely discharged via the second gas curtain. If the two gas curtains form at an angle with each other, as the main flow directions are at an angle to each other, the individual properties of each gas curtain can be specifically influenced. Of course, it is also conceivable that the gas curtains mix with each other after a certain distance from the nozzle outlet. It is also conceivable that, depending on the driving situation, only one of the two gas curtains is operated by a selective control of the nozzle arrangements.

The invention is explained in greater detail below based on exemplary embodiments shown in the drawings. In the drawings

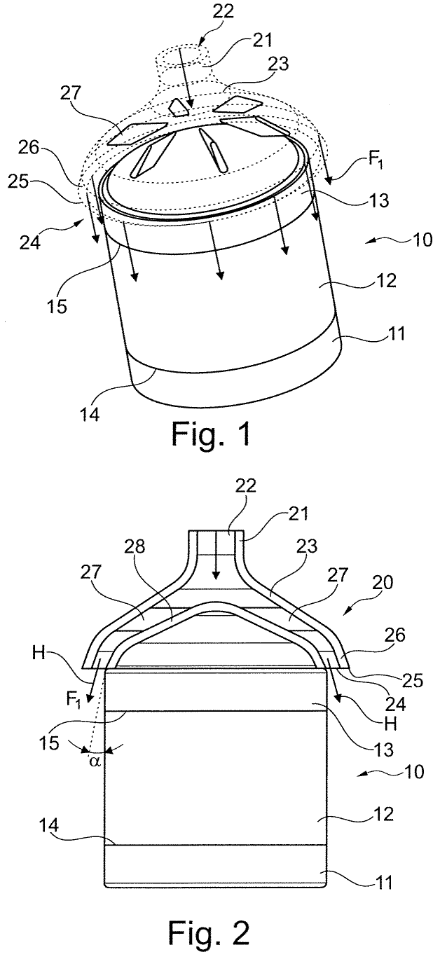

FIG. 1 shows a perspective view of an optical sensor,

FIG. 2 shows a full section of the optical sensor of FIG. 1,

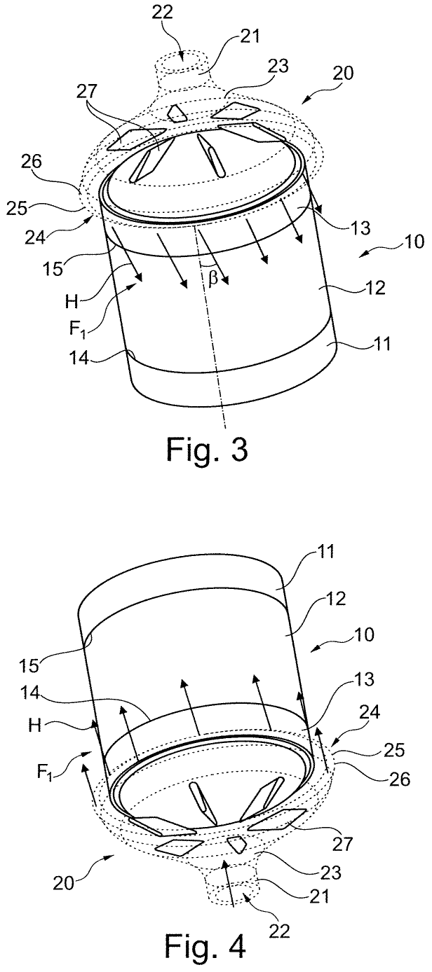

FIG. 3 shows a perspective view of a second alternative of an optical sensor,

FIG. 4 shows a perspective view of a third alternative of an optical sensor,

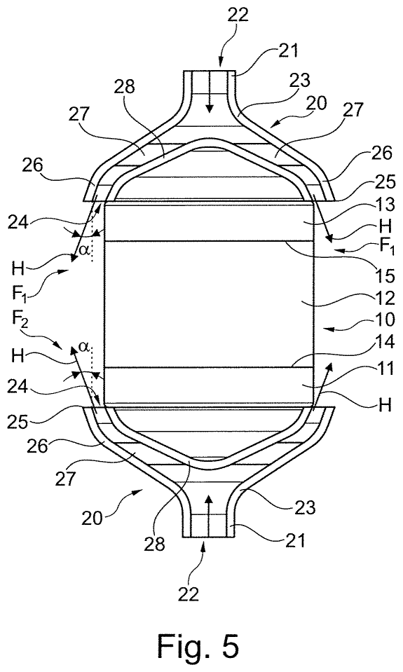

FIG. 5 shows a full section of a fourth alternative of an optical sensor,

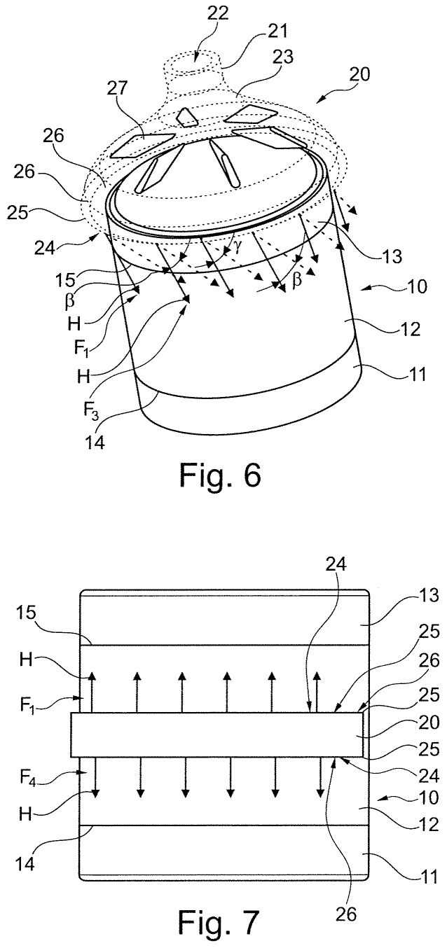

FIG. 6 shows a perspective view of a fifth alternative of an optical sensor and,

FIG. 7 shows a full section of a sixth alternative of an optical sensor.

FIG. 1 shows an optical sensor, namely a lidar sensor 10, in which an optical unit is mounted in a receiving space. The receiving space is surrounded by a light-emitting surface 12. The light-emitting surface 12 is used to separate the receiving space from its surroundings. At opposite lateral edges 14 and 15 of the light-emitting surface 12, the receiving space is delimited by supports 11 and 13. The light-emitting surface 12 can have a cylindrical outer surface, as shown in the drawings. However, it is also conceivable to use a flat or otherwise curved light-emitting surface 12. The light-emitting surface 12 is formed by a transparent material, at least sectionally. The light-emitting surface 12 is designed in such a way that it can transmit light, in particular laser light, which the optical unit emits inside the receiving space. The transparent light-emitting surface 12 can transmit reflected laser light from the surroundings through the light-emitting surface 12 into the receiving space. The design and function of such lidar sensors 10 is basically known from the prior art.

Such lidar sensors 10 can be used in the context of the invention, in particular in motor vehicles, preferably in passenger cars. They are used to monitor the area around the vehicle. In particular, such lidar sensors 10 are increasingly being used to monitor the surroundings during autonomous driving. Accordingly, these lidar sensors 10 can be exposed to the environmental conditions acting on the vehicle.

As FIGS. 1 and 2 show, a protective device 20 is assigned to the lidar sensor 10, preferably connected thereto, to obtain a uniformly manageable structural component.

The protective device 20 has a gas guide 21, which is accessible on the inlet end via an inflow opening 22. The inflow opening 22 can be used to connect the protective device 20 to a gas supply, in particular an air supply. To this end, provision may be made for a connection port to be provided in the area of the inflow opening 22, to which a gas supply duct can be connected. Preferably, the protective device 20 is assigned to a compressed air system, wherein it may be possible for the compressed air system to have a compressor, which is used to draw in air from the surroundings and compress and feed it to the inflow opening 22.

Downstream of the inflow opening 22, there is a duct arrangement in the protective device 20 by means of which the gas supplied via the inflow opening 22 can be fed to at least one nozzle arrangement 26. The duct arrangement may have a distributor 23, which is used to divide the gas flow to feed it to one or more nozzles of the at least one nozzle arrangement 26.

In the exemplary embodiment shown in FIGS. 1 and 2, the nozzle arrangement 26 has a nozzle 24, which can be designed as an at least partially circumferential ring nozzle. The ring nozzle can be designed to be continuous in the circumferential area. However, it is also conceivable that the ring nozzle is made up of individual nozzle segments.

The nozzle 25 has a nozzle outlet 24. In accordance with FIG. 2, in the longitudinal direction this nozzle outlet 24 is disposed spaced apart from the light-emitting surface 12. Additionally or alternatively, provision may also be made for the nozzle outlet 24 to be disposed spaced apart in a direction perpendicular to the light-emitting surface 12. Accordingly, in this exemplary embodiment, the nozzle outlet 24 may be disposed radially outwards relative to the light-emitting surface 12. In this exemplary embodiment, the outlet surface of the nozzle outlet 24 is slightly offset radially inwards relative to the light-emitting surface 12. However, it is also conceivable that the inner nozzle edge of the nozzle outlet 24 is aligned with the surface of the light-emitting surface 12. These embodiments shall also be possible in the context of the invention.

The protective device 20 can be designed such that it has one or more duct sections downstream of the inflow opening 22 and or downstream of the distributor 23 and connected to the inflow opening 22, for instance connected to the distributor 23, inside which the free flow cross-section is smaller than the flow cross-section. This accelerates the flow in the duct sections and thus increases the kinetic energy of the gas flow. Preferably, the flow cross-section in at least one channel section is continuously tapered, at least sectionally, to avoid flow losses.

The illustration in FIG. 2 shows that at least one guide element 27 can be present in the gas guide of the protective device 20. By means of the at least one guide element 27, the gas flow of the gas supply can be directed to the assigned nozzle(s) 25.

In the exemplary embodiment shown in FIG. 2, the gas flow exits the protective device 20 through the nozzle outlet(s) 24. A directed gas flow is generated by means of the gas flow in such a way that the gas flow on the ambient side generates a gas curtain F1 along the light-emitting surface 12. In the exemplary embodiment shown, the gas curtain F1 is disposed spaced apart from the light-emitting surface 12, at least sectionally.

In terms of the invention, this means that the main flow direction H of the gas stream is at a distance from the light-emitting surface 12 to generate the gas curtain F1. Parts of the gas flow, such as vortices or the like, may touch the light-emitting surface 12. Because the main flow direction H extends spaced apart from the light-emitting surface 12, the gas curtain F1 is nevertheless disposed spaced apart from the light-emitting surface 12 in terms of the invention.

As FIG. 2 shows, the main flow direction H in the area of the nozzle outlet 24 is such that the gas curtain F1 is generated in the direction from the first lateral edge 15 towards the opposite lateral edge 14 of the lidar sensor 10.

The main flow direction H can extend in parallel to the light-emitting surface 12. Accordingly, the main flow direction H can extend in parallel to the central longitudinal axis of the cylindrical light-emitting surface 12.

However, FIG. 2 shows that the main flow direction H with the light-emitting surface 12 may also form an angle a measured outwards perpendicular to the light-emitting surface 12. This angle can be selected in the range from 0° to 60°, preferably in the range from 0° to 30°, particularly preferably from 0° to 15°.

It is conceivable that at least one guide element 27 is preferably disposed in the tapering channel section. Functionally, the at least one guide element 27 can be designed to change the direction of flow of the gas guided in the gas supply. Thus, the flow direction can be changed in such a way that the gas flowing out of the nozzle outlet 24 is influenced with regard to its main flow direction H.

FIG. 3 shows an embodiment variant in which the main flow direction H in the area of the nozzle outlet(s) 24 extends spaced apart from the light-emitting surface 12 to generate a gas curtain F1 in front of the light-emitting surface 12. The main flow direction H has a component that extends in the circumferential direction of the light-emitting surface 12. In particular, the main direction of flow H can be inclined in the circumferential direction of the cylindrical or partially cylindrical light-emitting surface 12, wherein preferably the angle of inclination @ is selected in the range from 0° to 30°. It is conceivable to achieve this main flow direction H, which is inclined in the circumferential direction, by arranging the at least one guide element 27 in the gas guide 21 at an appropriate angle to achieve the desired flow direction.

In addition or alternatively, in the embodiment variant according to FIG. 3, an inclination of the main flow direction H away from the light-emitting surface 12 may also be provided, as is also implemented in the exemplary embodiment according to FIG. 2.

FIG. 2 further shows that the protective device 20 can have a base 28, which can be used to partially limit the gas supply 21. Furthermore, the base 28 may form a connection area by means of which the protective device 20 can be firmly connected to the support 13 of the lidar sensor 10.

Apart from the differences described above, the exemplary embodiment 3 is essentially equal to the exemplary embodiment shown in FIGS. 1 and 2, i.e., reference can be made to the above explanations.

FIG. 4 illustrates that the protective device 20, as shown for instance in FIGS. 1 to 3, can also be disposed on the underside of the lidar sensor 10, for instance connected to the lower support F. In this case, a gas curtain F1 is generated, which is guided in front of the light-emitting surface 12 from the lower lateral edge 14 to the upper lateral edge 15 of the light-emitting surface.

FIG. 5 shows an embodiment, in which two protective devices 20 can be disposed on opposite ends of the light-emitting surface 12, for instance in the area of the lateral edges 14, 15. The protective devices 20 can be designed as shown in FIGS. 1 to 4.

The upper protective device 20 generates a gas curtain F1 in front of the light-emitting surface 12, which is directed in the direction from the upper lateral edge 15 to the lower lateral edge 14. The lower protective device 20 generates a gas curtain F2, which is directed in front of the light-emitting surface 12 in the direction from the lower lateral edge 14 to the upper lateral edge 15.

FIG. 6 shows a protective device 20, which has two nozzle arrangements 26, wherein the nozzle arrangements 26 are disposed sequentially perpendicular to the light-emitting surface 12. As FIG. 6 shows, each nozzle arrangement 26 may have an at least partially circumferential nozzle 25 or several nozzles 25 disposed sequentially. The first nozzle arrangement 26 generates a gas curtain F1 as shown in FIGS. 1 to 5. The second nozzle arrangement 26 is used to generate a gas curtain F3, which is disposed radially outwards spaced apart from the inner gas curtain F1. The outer gas curtain F3 can be designed as shown in FIGS. 1 to 5. In particular, the main flow directions H of the two gas curtains F1 and F3 may differ from each other. FIG. 6 illustrates that the vectors representing the main flow directions H form an angle y with each other.

FIG. 7 shows a further alternative invention that can use a lidar sensor 10 as shown in FIGS. 1 to 6. As this drawing illustrates, the protective device 20 has nozzle arrangements 26 on opposite ends, each having one or more nozzles 25, to generate two at least partially circumferential gas curtains F1 and F4 in the circumferential direction.

The protective device 20 is disposed in an area in front of the light-emitting surface 12 of the lidar sensor 10. The arrangement of the protective device 20 is preferably selected such that it is disposed in an area in front of the light-emitting surface 12 that is not required for the transmission of light from the optical unit disposed in the receiving space.

The upper nozzle arrangement 26 generates a gas curtain F1, which extends from the nozzle arrangement 26 towards the upper lateral edge 15 of the light-emitting surface 12.

The upper nozzle arrangement 26 generates a gas curtain F4, which extends from the nozzle arrangement 26 towards the lower lateral edge 14 of the light-emitting surface 12.

The protective devices 20 described above can be used to create a gas curtain F1 F4 in front of the light-emitting surface 12, which gas curtain prevents particles from the surroundings from hitting the light-emitting surface 12. These particles are intercepted and discharged by the gas curtain F1-F4. In this way, the light-emitting surface 12 is not contaminated. At the very least, soiling is greatly reduced.

1-12. (canceled)

13. An optical sensor apparatus, comprising:
a lidar sensor including a transparent light-emitting surface configured to transmit laser light from the lidar sensor towards a surrounding environment and/or to transmit light from the surrounding environment to the lidar sensor; and
a protective device including at least one nozzle configured to provide a directed gas flow to generate a gas curtain protecting at least a portion of the transparent light-emitting surface facing the surrounding environment from contamination.

14. The optical sensor apparatus of claim 13, wherein:
the gas curtain is at least partially spaced apart from the transparent light-emitting surface.

15. The optical sensor apparatus of claim 13, wherein:
the at least one nozzle is configured such that a main flow direction of the directed gas flow from a nozzle outlet of the at least one nozzle extends in parallel to or at an angle away from the transparent light-emitting surface.

16. The optical sensor apparatus of claim 13, wherein:
the at least one nozzle is configured such that a main flow direction of the directed gas flow from a nozzle outlet of the at least one nozzle extends at an angle away from the transparent light-emitting surface of no greater than 60°.

17. The optical sensor apparatus of claim 13, wherein:
the at least one nozzle is configured such that a main flow direction of the directed gas flow from a nozzle outlet of the at least one nozzle extends at an angle away from the transparent light-emitting surface of no greater than 30°.

18. The optical sensor apparatus of claim 13, wherein:
the at least one nozzle is configured such that a main flow direction of the directed gas flow from a nozzle outlet of the at least one nozzle extends at an angle away from the transparent light-emitting surface of no greater than 15°.

19. The optical sensor apparatus of claim 13, wherein:
the transparent light-emitting surface is at least in part a plane surface and the gas curtain is directed in front of the plane surface.

20. The optical sensor apparatus of claim 13, wherein:
the transparent light-emitting surface is at least in part a cylindrical surface and the gas curtain is directed in front of the cylindrical surface.

21. The optical sensor apparatus of claim 20, wherein:
a main flow direction of the directed gas flow is inclined in a circumferential direction.

22. The optical sensor apparatus of claim 20, wherein:
a main flow direction of the directed gas flow is inclined in a circumferential direction by an angle of inclination of no greater than 30°.

23. The optical sensor apparatus of claim 13, wherein:
the at least one nozzle includes a nozzle surface defining a nozzle outlet, which nozzle surface is spaced apart from the transparent light-emitting surface.

24. The optical sensor apparatus of claim 13, wherein:
the at least one nozzle includes first and second nozzles located at opposite ends of the transparent light-emitting surface and facing towards each other.

25. The optical sensor apparatus of claim 13, wherein:
the protective device further includes at least one support delimiting the transparent light-emitting surface and the at least one support supports the at least one nozzle.

26. The optical sensor apparatus of claim 13, wherein:
the transparent light-emitting surface is delimited on opposite ends by first and second lateral edges; and
the at least one nozzle is located between the first and second lateral edges.

27. The optical sensor apparatus of claim 26, wherein:
the at least one nozzle includes at least a first nozzle facing the first lateral edge and a second nozzle facing the second lateral edge.

28. The optical sensor apparatus of claim 13, wherein:
the transparent light-emitting surface is at least in part a cylindrical surface and the gas curtain is directed in front of the cylindrical surface; and
the at least one nozzle includes at least one continuous or discontinuous ring nozzle.

29. The optical sensor apparatus of claim 13, wherein:
the transparent light-emitting surface is at least in part a cylindrical surface and the gas curtain is directed in front of the cylindrical surface; and
the at least one nozzle includes a plurality of individual nozzles.

30. The optical sensor apparatus of claim 13, wherein:
the at least one nozzle includes first and second nozzle arrangements disposed sequentially perpendicular to the transparent light-emitting surface, and a main flow direction of the directed gas flow from each of the first and second nozzle arrangements extend parallel to each other.

31. The optical sensor apparatus of claim 13, wherein:
the at least one nozzle includes first and second nozzle arrangements disposed sequentially perpendicular to the transparent light-emitting surface, and a main flow direction of the directed gas flow from each of the first and second nozzle arrangements extend at a non-parallel angle to each other in a circumferential direction.
